(19) United States
(12) Patent Application Publication
(10) Pub. No.: US 2026/0166436 A1
(43) Pub. Date: Jun. 18, 2026

(54) GAME OBJECT EDITING METHOD AND APPARATUS, AND ELECTRONIC DEVICE

(71) Applicant: NETEASE (HANGZHOU) NETWORK CO., LTD., Hangzhou, Zhejiang (CN)

(72) Inventors: Shaoshi BANG, Hangzhou, Zhejiang (CN); Jianwu HUANG, Hangzhou, Zhejiang (CN)

(73) Assignee: NETEASE (HANGZHOU) NETWORK CO., LTD., Hangzhou, Zhejiang (CN)

(21) Appl. No.: 18/712,732

(22) PCT Filed: Nov. 15, 2022
(86) PCT No.: PCT/CN2022/132048

§ 371 Date: May 23, 2024

(30) Foreign Application Priority Data
Jan. 26, 2022 (CN) 202210092395.7

(51) Int. Cl. A63F 13/60; G06F 3/0482; G06F 3/04845; G06T 13/20; G06T 19/20

(52) U.S. Cl. CPC A63F 13/60; G06F 3/04845; G06T 13/20; G06T 19/20; G06F 3/0482; G06T 2200/24; G06T 2219/2012

(57) ABSTRACT

A method for editing a game object includes displaying on a graphical user interface, in response to a loading operation for a target resource, a target sequence frame corresponding to the target resource, where the graphical user interface includes an object offset control, the target sequence frame includes a virtual object and an associated object of the virtual object, and the target resource includes linking information of the virtual object and linking information of the associated object; controlling, in response to a first operation on the object offset control, a designated object in the target sequence frame to move, where the designated object includes the virtual object or the associated object; and updating, based on a position of the designated object after moving, the linking information of the designated object.

The present disclosure claims the priority to the Patent Application No. 202210092395.7, entitled “GAME OBJECT EDITING METHOD AND APPARATUS, AND ELECTRONIC DEVICE”, submitted to the Chinese Patent Office on Jan. 26, 2022, and the entire contents of which are incorporated into the present disclosure by reference.

### TECHNICAL FIELD

The present disclosure relates to the field of game model developing technologies, and in particular to a method and apparatus for editing a game object, and an electronic device.

### BACKGROUND

Rendering three into two refers to rendering a 3D animation into a 2D animation. The development of game models with types of rendering three into two generally requires rendering the animation of the 3D model into a series of sequence frames, linking the character model to the 3D model through predetermined linking points, and completing the dynamic effect of the 3D model by replacing the sequence frames. In related art, it is typically required to determine and output in a related software art resources of the completed game model, which include the character and sequence frame pictures as well as linking points, then input the output game model into an editor and check whether there is any problem with the game model, and if there is a problem, such as an inappropriate linking point of the game model, it is required to readjust in the software the linking point position, re-render the game model by means of a grid and output the game model after rendering. If there are more types of character models or the material of the game model is relatively complex, it is required to take a long time to adjust and render in the software. The operation of this method is relatively cumbersome, with a high labor and time cost, and the animation effect of the game model obtained through rendering is not good.

### SUMMARY

In view of the foregoing, an object of the present disclosure is to provide a method and apparatus for editing a game object, and an electronic device, in order to simplify the developing process of the game object, reduce the labor and time cost, and improve the animation effect of the game object at the same time.

In a first aspect, embodiments of the present disclosure provide a method for editing a game object, where a graphical user interface is provided through a terminal device, the graphical user interface includes an object offset control, and the method includes: displaying on the graphical user interface, in response to a loading operation for a target resource, a target sequence frame corresponding to the target resource, where the target sequence frame includes a virtual object and an associated object of the virtual object, and the target resource further includes linking information of the virtual object and linking information of the associated object; controlling, in response to a first operation on the object offset control, a designated object in the target sequence frame to move, where the designated object includes the virtual object or the associated object; and updating, based on a position of the designated object after moving, the linking information of the designated object.

The object offset control includes a plurality of object offset sub-controls, each of the object offset sub-controls corresponds to an offset direction, and offset directions corresponding to different object offset sub-controls are different. The controlling, in response to the first operation on the object offset control, the designated object in the target sequence frame to move includes: controlling, in response to a triggering operation on a first object offset sub-control in the plurality of object offset sub-controls, the designated object to move in a first offset direction corresponding to the first object offset sub-control.

Furthermore, the graphical user interface further includes an object saving control; and the updating, based on the position of the designated object after moving, the linking information of the designated object includes: obtaining, in response to a triggering operation on the object saving control, first linking information corresponding to the position of the designated object after moving, and determining the first linking information as the linking information of the designated object in the target sequence frame, and as the linking information of the designated object in sequence frames other than the target sequence frame in the target resource; and saving the first linking information to the target resource.

Furthermore, the obtaining the first linking information corresponding to the position of the designated object after moving includes: obtaining first position information corresponding to the position of the designated object after moving; and obtaining the first linking information by converting the first position information into pixel position information corresponding to the designated object.

Furthermore, the graphical user interface further includes a target sequence frame offset control, and the method further includes: controlling, in response to a second operation on the target sequence frame offset control, the target sequence frame to move; and updating, based on a position of the target sequence frame after moving, position information of the target sequence frame.

Furthermore, the target sequence frame offset control includes a plurality of target sequence frame offset sub-controls, each of the target sequence frame offset sub-controls corresponds to an offset direction, and offset directions corresponding to different target sequence frame offset sub-controls are different; and the controlling, in response to the second operation on the target sequence frame offset control, the target sequence frame to move includes: in response to a triggering operation on a first target sequence frame offset sub-control in the plurality of target sequence frame offset sub-controls, controlling the target sequence frame to move in a first offset direction corresponding to the first target sequence frame offset sub-control, and displaying a moving action image of the target sequence frame.

Furthermore, the graphical user interface further includes a target sequence frame saving control; and the updating, based on the position of the target sequence frame after moving, the position information of the target sequence frame includes: obtaining, in response to a triggering operation on the target sequence frame saving control, second position information of the current target sequence frame, and determining the second position information as the position information of the current target sequence frame, and as position information of all sequence frames corresponding to the target resource; and updating the second position information to the target resource.

Furthermore, the graphical user interface further includes a target sequence frame editing control, and the method further includes: displaying, in response to a triggering operation on the target sequence frame editing control, a depth map of the target sequence frame, where a background image of the depth map is a mask map of the target sequence frame; and determining, in response to a color editing operation for the depth map, shielding relationship information between the virtual object and the associated object.

Furthermore, the mask map of the target sequence frame is determined by a step of: determining, based on first linking information of the designated object in the target sequence frame, a mask map of the virtual object, where the mask map includes a first color region and a second color region, and the associated object of the virtual object is located in an intermediate region between the first color region and the second color region.

Furthermore, the determining, in response to the color editing operation for the depth map, the shielding relationship information between the virtual object and the associated object includes: determining, in response to a first color filling operation for a designated region in the depth map, the shielding relationship information between the virtual object and the associated object in the designated region as the virtual object shielding the associated object; and determining, in response to a second color filling operation for the designated region in the depth map, the shielding relationship information between the virtual object and the associated object in the designated region as the associated object shielding the virtual object.

Furthermore, the graphical user interface further includes an object saving control, and the method further includes: obtaining, in response to a triggering operation on the object saving control, a spatial position corresponding to the linking information of the designated object; generating a target material by converting the spatial position corresponding to the linking information into a material, where a midpoint of the target material is the spatial position corresponding to the linking information; and imparting the target material as produced to the virtual object, rendering the virtual object, and saving the virtual object as rendered.

Furthermore, the graphical user interface further includes a resource loading control; and the displaying on the graphical user interface, in response to the loading operation for the target resource, the target sequence frame corresponding to the target resource includes: obtaining resource path information of the target resource; and displaying on the graphical user interface, in response to a triggering operation on the resource loading control, the target sequence frame corresponding to the target resource.

Furthermore, the graphical user interface further includes a resource path input box and a resource path selecting control; and the obtaining the resource path information of the target resource includes: obtaining the resource path information of the target resource in response to an input operation, in the resource path input box, of the resource path information of the target resource; or displaying selectable resource path information in response to a triggering operation on the resource path selecting control, and obtaining the resource path information of the target resource in response to a selecting operation for the resource path information of the target resource in the selectable resource path information.

Furthermore, the graphical user interface further includes an animation playing control, and the method further includes: playing, in response to a triggering operation on the animation playing control, an action image corresponding to the target sequence frame.

Furthermore, the graphical user interface further includes a plurality of background image displaying controls, and the method further includes: displaying in a background region of the target sequence frame, in response to a triggering operation on a first background image displaying control in the plurality of background image displaying controls, a first background image corresponding to the first background image displaying control.

Furthermore, the graphical user interface further includes a text displaying control, and the method further includes: displaying, in response to a triggering operation on the text displaying control, a preset text at a designated position of the graphical user interface.

Furthermore, the graphical user interface further includes a copy offset control, and the method further includes: obtaining, in response to a triggering operation on the copy offset control, the linking information of the designated object in the current target sequence frame; and saving, in response to a switching operation for the current target sequence frame, the linking information of the designated object in the current target sequence frame to a sequence frame corresponding to the switching operation.

In a second aspect, the embodiments of the present disclosure provide an apparatus for editing a game object, where a graphical user interface is provided through a terminal device, the graphical user interface includes an object offset control, and the apparatus includes: a displaying module, configured to display on the graphical user interface, in response to a loading operation for a target resource, a target sequence frame corresponding to the target resource, where the target sequence frame includes a virtual object and an associated object of the virtual object, and the target resource further includes linking information of the virtual object and linking information of the associated object; a controlling module, configured to control, in response to a first operation on the object offset control, a designated object in the target sequence frame to move, where the designated object includes the virtual object or the associated object; and an updating module, configured to update, based on a position of the designated object after moving, the linking information of the designated object.

In a third aspect, the embodiments of the present disclosure provide an electronic device including a processor and a memory, where the memory stores a computer-executable instruction capable of being executed by the processor, and the processor, through executing the computer-executable instruction, implements the method for editing the game object according to any one of the first aspect.

In a fourth aspect, the embodiments of the present disclosure provide a computer-readable storage medium, where the computer-readable storage medium stores a computer-executable instruction, and the computer-executable instruction, when invoked and executed by a processor, causes the processor to implement the method for editing the game object according to any one of the first aspect.

The embodiments of the present disclosure bring about the following beneficial effects.

The present disclosure provides a method and apparatus for editing a game object, and an electronic device, the target sequence frame corresponding to the target resource is displayed in response to the loading operation for the target resource, where the target sequence frame includes the virtual object and the associated object of the virtual object, and the target resource further includes the linking information of the virtual object and the linking information of the associated object; the designated object in the target sequence frame is controlled to move in response to the first operation on the object offset control, where the designated object includes the virtual object or the associated object; and the linking information of the designated object is updated based on the position of the designated object after moving. This method allows for editing the target sequence frame corresponding to the target resource through direct viewing, controlling the movement of the designated object through the object offset control, displaying the target sequence frame after the movement in real time, updating the linking information of the designated object by controlling the movement of the designated object, which is simple and clear to operate, simplifies the developing process of the game object, reduces the labor and time cost, and improves the animation effect of the game object.

Other features and advantages of the present disclosure will be set forth in the subsequent specification and, in part, will become apparent from the specification or will be understood by implementing the present disclosure. The purposes and other advantages of the present disclosure are achieved and obtained in the structure specifically indicated in the specification, the claims, and the accompanying drawings.

In order to make the above objects, features and advantages of the present disclosure more apparent and understandable, the following provides a detailed explanation by illustrating preferred embodiments in combination with the accompanying drawings.

### BRIEF DESCRIPTION OF THE DRAWINGS

In order to more clearly illustrate technical solutions in the detailed description of the present disclosure or technical solutions in prior art, the following will briefly introduce the accompanying drawings that need to be used in the description of the detailed description or prior art, and it is obvious that the accompanying drawings in the following description are some of the embodiments of the present disclosure, and for those skilled in the art, other accompanying drawings can be obtained according to these drawings without creative labor.

FIG. 1 is a flowchart of a method for editing a game object provided by an embodiment of the present disclosure.

FIG. 2 is a schematic diagram of a graphical user interface provided by an embodiment of the present disclosure.

FIG. 3 is a schematic diagram of another graphical user interface provided by an embodiment of the present disclosure.

FIG. 4 is a schematic diagram of another graphical user interface provided by an embodiment of the present disclosure.

FIG. 5 is a schematic diagram of another graphical user interface provided by an embodiment of the present disclosure.

FIG. 6 is a schematic diagram of another graphical user interface provided by an embodiment of the present disclosure.

FIG. 7 is a schematic structural diagram of an apparatus for editing a game object provided by an embodiment of the present disclosure.

FIG. 8 is a schematic structural diagram of an electronic device provided by an embodiment of the present disclosure.

### DETAILED DESCRIPTION

In order to make the objects, technical solutions and advantages of the embodiments of the present disclosure clearer, the technical solutions of the present disclosure will be described clearly and completely in the following in connection with the accompanying drawings, and it is obvious that the described embodiments are a part of the embodiments of the present disclosure, but not all of the embodiments. Based on the embodiments in the present disclosure, all other embodiments obtained by those skilled in the art without making creative labor fall within the scope of protection of the present disclosure.

Rendering three into two refers to rendering a 3D animation into a 2D animation. Typically, the development of game mounts with types of rendering three into two requires rendering the animation of a three-dimensional model mount into a series of 2D sequence frames, and while rendering the sequence frame resources, a black-and-white depth map may also be rendered to differentiate levels, i.e., the shielding relationship between the mount and the character, which is achieved by splitting the mount into two pieces. One of the pieces is placed in an upper layer of the character to indicate that the mount shields the character, and one of the pieces is placed in a lower layer of the character to indicate that the character shields the mount. The character is linked to the mount through predetermined linking points, and the dynamic effect of the mount is completed by replacing the sequence frame pictures.

In the related art, it is typically required to determine and output in a related software, i.e., a digital content create (DCC) software, a kind of software related to the creation of digital contents, such as the Maya software (a kind of 3D modelling and animation software), 3DS Max software (a 3D Studio Max software, a kind of 3D modelling rendering and animation production), etc. the art resources of the completed game mount and character, which include the character and sequence frame pictures as well as the linking points. Then, in the game engine, linking point debugging is carried out by attaching a Mesh (i.e., grid). Specifically, by performing a UV splitting (a concept in polygon modeling, which is mainly the number that records corresponding relationships between vertices of the model in the 3D space and the two-dimensional map space) for the patch model, sequence frame pictures are mapped out, and the linking point positions on the Mesh are adjusted, then the linking point displacement of all sequence frame pictures can be completed.

Finally, the output target resource, i.e., the mount and the character, is input into the editor, and whether there is any problem with the game mount and the character is checked. Only when there is no problem can the target resource be submitted for game testing. Typically, the following points are checked.
1. If there is a problem with the character linking point, the artist needs to return to the DCC software to readjust the character linking point and output, and if the character has more body types, there may be a situation such as difficulty in unifying, and it is difficult to debug to a point where all body types are suitable, so it will take a long time and effort.
2. If there is a problem with the mount linking point, the artist needs to adjust the root skeleton of the mount and perform re-rendering, if the mount's material is more complex, it will take a longer time to render, and if the number of adjustments is higher, it may take a whole day.

Therefore, the operation of the above method is relatively cumbersome, with a high labor and time cost, and the animation effect of the game model obtained through rendering is not good. Based on this, the embodiments of the present disclosure provide a method and apparatus for editing a game object, and an electronic device, and this technology may be applied to a device provided with an object editor.

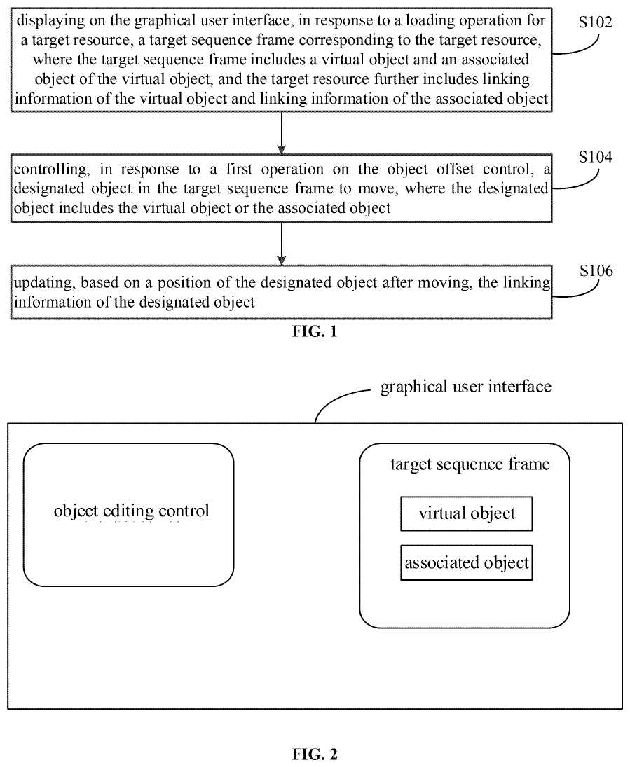

To facilitate the understanding of the present embodiments, a detailed description of a method for editing a game object disclosed in the embodiments of the present disclosure is first provided, where a graphical user interface is provided through a terminal device, and the graphical user interface includes an object offset control. As shown in FIG. 1, the method includes the following steps S102 to S106.

At step S102, a target sequence frame corresponding to a target resource is displayed on the graphical user interface in response to a loading operation for the target resource, where the target sequence frame includes a virtual object and an associated object of the virtual object, and the target resource further includes linking information of the virtual object and linking information of the associated object.

The above target resource typically refers to the resource output after the art production is completed, and includes the sequence frame pictures of the game object and the game object; typically, the target resource includes a series of sequence frame pictures of the virtual object, and each of the sequence frame pictures is linked with the associated object corresponding to the sequence frame picture, therefore, the above target sequence frame includes the virtual object and the associated object of the virtual object. The virtual object described above may be a game mount, or other objects having a linking relationship with the virtual character, such as a virtual cloud, a virtual vehicle, and the like. The aforesaid associated object typically refers to a virtual character, and the virtual character is typically a preset persona character in the game. In a game scenario, the virtual character may be linked on the virtual mount to increase the movement speed, skill damage, and the like of the virtual character.

The linking information described above includes the linking information of the virtual object, and includes the linking information of the associated object. In some embodiments, the linking information of the virtual object includes the linking point position information of the virtual object in each sequence frame, and the linking information of the associated object includes the linking point position information of the associated object in each sequence frame. The above graphical user interface refers to the user interface of the object editor, and visual editing operations may be performed on this interface for the above target sequence frame.

In an actual implementation, the target resource may be selected on the graphical user interface, then the resource loading control is clicked on, and this may cause that the target sequence frame of the target resource object is loaded into the editor, and the target sequence frame corresponding to the target resource is displayed in a designated area of the graphical user interface at the same time. Typically, the target sequence frame is randomly selected from a plurality of sequence frames corresponding to the target resource. The actual loading process is typically to load the virtual object, the associated object, the linking information of the virtual object, and the linking information of the associated object respectively, and then link the associated object to the virtual object based on the linking information of the virtual object and the linking information of the associated object, and finally display that as the target sequence frame in the designated area. In some embodiments, the virtual object described above is a 2D picture, and the associated object described above is a 3D model. As shown in FIG. 2, the graphical user interface displays the target sequence frame in the designated area of the interface, and the target sequence frame includes the virtual object and the associated object.

At step S104, in response to a first operation on the object offset control, a designated object in the target sequence frame is controlled to move, where the designated object includes the virtual object or the associated object.

The above object offset control is used for controlling the object in the target sequence frame to move, and in order to simplify the operation of the developer, a plurality of offset controls with fixed moving directions may be preset, and the developer may control, through clicking on the offset controls in different directions, the designated object to move in the direction, where the distance of the moving may be preset according to the actual need.

Since the target sequence frame includes the virtual object and the associated object, and both objects are provided with the linking point information, when the linking point is debugged, it is required to debug the linking point position of each object separately. Therefore, the above object offset control typically includes an object offset control for the virtual object and includes an object offset control for the associated object. Alternatively, the above object offset control is only one, which may be used to perform offset control for different objects separately, in which case the object to be controlled may be pre-selected, and then offset control may be performed on the selected object through the object offset control. The first operation described above may be clicking through the mouse on the offset controls in different directions in the object offset control, for example, if the object is intended to be controlled to move upward, the offset control with an upward direction may be clicked on through the mouse; or the first operation described above may be inputting through the keyboard the instruction corresponding to different directions in the object offset control, for example, if the object is intended to be controlled to move upward, the “↑” in the keyboard may be input.

For example, the developer may click on the object offset control for the associated object, and by clicking on the control that corresponds to the direction in which the developer intends to move the associated object, for example, by clicking on the control that corresponds to moving upward, the developer may control the associated object to move up for a preset distance from an initial position. At this time, the moving process may be displayed on the graphical user interface. Additionally, the developer may click on the object offset control for the virtual object, and by clicking on the control that corresponds to the direction in which the developer intends to move the virtual object, for example, by clicking on the control that corresponds to moving upward, the developer may control the virtual object to move up for a preset distance from an initial position. At this time, the moving process may be displayed on the graphical user interface.

It can be understood that the virtual object in the target sequence frame is controlled to move in response to the first operation on the object offset control for the virtual object, and the associated object in the target sequence frame is controlled to move in response to the first operation on the object offset control for the associated object. The purpose of this embodiment is to adjust the linking point position of the associated object in the target sequence frame by controlling the movement of the associated object. In some embodiments, the associated object in the target sequence frame is a 3D model, and the linking point position of the associated object refers to the center point in the associated object that is in contact with, or in combination with, the virtual object. The linking point position of the virtual object in the target sequence frame may be adjusted by controlling the movement of the virtual object. Since the virtual object in the target sequence frame is a 2D picture, the linking point of the virtual object may also be called the picture K-point, which indicates a position in the picture suitable for linking.

At step S106, the linking information of the designated object is updated based on a position of the designated object after moving.

The above-described linking information of the designated object includes the linking point position of the associated object in each sequence frame in the target resource, and the linking point position of the virtual object in each sequence frame in the target resource. Specifically, after the designated object is controlled to move, the position of the designated object after moving is displayed on the graphical user interface. Then, the linking information of the designated object corresponding to the position may be obtained based on the position of the designated object after moving; the linking information of the designated object includes the linking point position of the associated object or the linking point position of the virtual object, or the linking information of the designated object includes the linking point position of the associated object and the linking point position of the virtual object. After the linking information of the designated object is obtained, the initial linking information in the target resource may be updated, according to a saving operation of the developer, to the above-described linking information of the designated object.

The present disclosure provides a method for editing a game object, the target sequence frame corresponding to the target resource is displayed in response to the loading operation for the target resource, where the target sequence frame includes the virtual object and the associated object of the virtual object, and the target resource further includes the linking information of the virtual object and the linking information of the associated object; the designated object in the target sequence frame is controlled to move in response to the first operation on the object offset control, where the designated object includes the virtual object or the associated object; and the linking information of the designated object is updated based on the position of the designated object after moving. This method allows for editing the target sequence frame corresponding to the target resource through direct viewing, controlling the movement of the designated object through the object offset control, displaying the target sequence frame after the movement in real time, updating the linking information of the designated object by controlling the movement of the designated object, which is simple and clear to operate, simplifies the developing process of the game object, reduces the labor and time cost, and improves the animation effect of the game object.

The above object offset control includes a plurality of object offset sub-controls, each of the object offset sub-controls corresponds to an offset direction, and offset directions corresponding to different object offset sub-controls are different; the above object offset control may generally include four object offset sub-controls, where a first object offset sub-control corresponds to an offset direction of upward offset, a second object offset sub-control corresponds to an offset direction of downward offset, a third object offset sub-control corresponds to an offset direction of leftward offset, and a fourth object offset sub-control corresponds to an offset direction of rightward offset.

The following specifically describes how to control the designated object in the target sequence frame to move, and one possible implementation is: controlling, in response to a triggering operation on the first object offset sub-control in the plurality of object offset sub-controls, the designated object to move in a first offset direction corresponding to the first object offset sub-control.

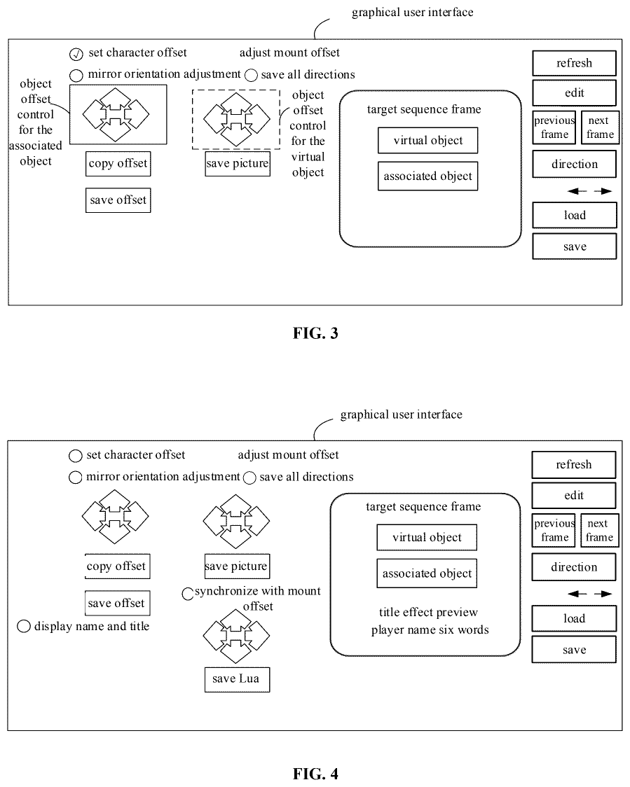

Specifically, as shown in FIG. 3, the above object offset control includes two types, where the object offset control in the solid line box is the object offset control of the associated object, and includes four sub-controls; and the object offset control in the dashed line box is the object offset control of the virtual object, and includes four sub-controls. It can be understood that the associated object is controlled, in response to the triggering operation on the first object offset sub-control in the plurality of object offset sub-controls of the associated object, to move in the first offset direction corresponding to the first object offset sub-control. The virtual object is controlled, in response to the triggering operation on the first object offset sub-control in the plurality of object offset sub-controls of the virtual object, to move in the first offset direction corresponding to the first object offset sub-control.

In an actual implementation, it is required to tick the optional box in front of “set character offset” and “adjust mount offset” in FIG. 3 first. Then the object offset sub-control can be clicked on to control the offset of the designated object.

In addition, the graphical user interface as shown in FIG. 3 also includes an optional box of “mirror orientation adjustment”. If this box is selected, the movement of the designated object in the mirror target sequence frame may be adjusted while the designated object is controlled to move. If the developer intends to view the moving position of the designated object in the mirror target sequence frame, the developer may click on the “direction” control on the graphical user interface to display the display effect of the designated object in the mirror target sequence frame after moving.

In the above method, a plurality of sub-controls are provided on the graphical user interface, the developer can control the movement of the designated object by clicking on the sub-controls, and the moving image is displayed in real time, thereby achieving the desired linking effect. This allows for visualized debugging for the linking point of designated object, experiencing the linking effect. The operation is simple, greatly reducing the modification time of the production staff, achieving process optimization and cost reduction, and avoiding the complex operation of re-importing to the DCC software to modify the linking point information of the object and re-outputting. At the same time, it avoids the batch operation on the rendered sequence frame pictures by using the Mesh method, and avoids the problem that there is a need to change the linking information in the original resource when changing the linking point, re-bake the sequence frame pictures after changing the linking point of the resource, and output the rendered resource which is time-consuming and long-period.

The following specifically describes how to update the linking information of the designated object, and one possible implementation is: obtaining, in response to a triggering operation on an object saving control, first linking information corresponding to the position of the designated object after moving, and determining the first linking information as the linking information of the designated object in the target sequence frame, and as the linking information of the designated object in sequence frames other than the target sequence frame in the target resource; and saving the first linking information to the target resource.

Typically, the above-described graphical user interface includes an associated object saving control and a virtual object saving control, for example, as shown in FIG. 3, the save offset control is the above-described associated object saving control, and the save picture control is the above-described virtual object saving control.

Specifically, the developer, after moving the associated object to a satisfactory position, may click on the associated object saving control (corresponding to the save offset control in the figure), the terminal device or the back end of the terminal device may obtain, based on the position of the associated object after moving, the first linking information corresponding to the position of the associated object after moving, specifically the terminal device or the back end of the terminal device obtains the position information of the center point in the associated object after moving that is in combination with the virtual object, and then determines the first linking information as the linking information of the associated object in the target sequence frame, and as the linking information of the associated object in sequence frames other than the target sequence frame in the target resource, and finally saves the first linking information directly to the target resource to update and replace the initial linking information of the associated object.

In addition, the developer, after moving the virtual object to a satisfactory position, may click on the virtual object saving control (corresponding to the save picture control in the figure), the terminal device or the back end of the terminal device may obtain, based on the position of the virtual object after moving, the first linking information corresponding to the position of the virtual object after moving, specifically the terminal device or the back end of the terminal device obtains the position information of the center point in the virtual object after moving that is in combination with the associated object, and then determines the first linking information as the linking information of the virtual object in the target sequence frame, and as the linking information of the virtual object in sequence frames other than the target sequence frame in the target resource, and finally saves the first linking information directly to the target resource to update and replace the initial linking information of the virtual object. In addition, the graphical user interface also includes an optional box of “save all directions”, all the pictures may be saved by selecting this optional box and then clicking on the save picture.

In the above method, after the operation of adjusting the position of the designated object in the currently displayed target sequence frame, the object saving control can, after the linking information of the designated object in the target sequence frame is modified, directly batch process the linking information of the designated object in all the sequence frames at the same time and save updates to the target resource, thus avoiding the problem of a large amount of time required for modification due to the position offset of the linking points after the virtual object is moved. The above method is simple to operate, greatly reducing the modification time of the production staff, and achieving process optimization and cost reduction.

In addition, in the above step of obtaining the first linking information corresponding to the position of the designated object after moving, one possible implementation is: obtaining first position information corresponding to the position of the designated object after moving, and obtaining the first linking information by converting the first position information into pixel position information corresponding to the designated object.

Firstly, it should be illustrated that the implementing manner of the linking information of the virtual object and the linking information of the associated object included in the target resource is actually the same as the 3D production manner, i.e., creating a linking point and placing it at a suitable back position of the virtual object, and making the animation of the linking point well. Since the virtual object is a 2D object in the form of a picture that doesn't support skeleton output, it is only possible to make the program to read the position information of the linking point. The linking point information takes the world spatial position of Sphere01, i.e., the first position information mentioned above, and then the first position information is converted into the pixel position information corresponding to the designated object, i.e., the pixel position of the picture of the designated object. Based on the above implementation manner of the linking information, after the designated object is controlled to move, the first position information corresponding to the position of the designated object after moving is obtained, and then the first position information is converted into the pixel position information corresponding to the designated object, thereby obtaining the first linking information. There is no linking relationship in the animation of the linking point, and the linking point has its own animation. There is a slight fluctuation, not as big as the moving action, without rotation.

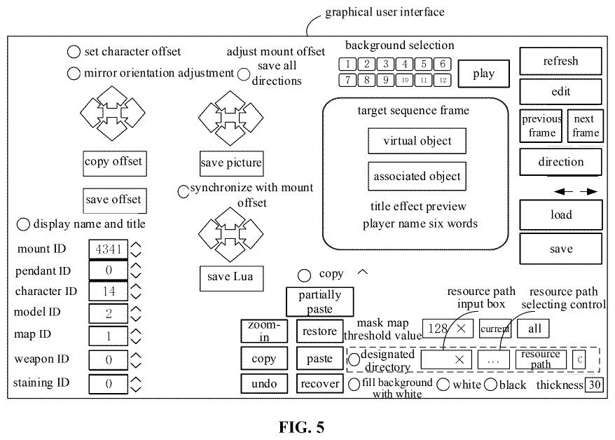

Since the identity information of the game object and the player may be displayed in the actual game scene for the game object, the above graphical user interface also includes a text displaying control, such as the control of “display name and title” as shown in FIG. 4, in order to improve the actual animation effect in the game. Specifically, a preset text is displayed at a designated position of the graphical user interface in response to a triggering operation on the text displaying control.

Since the player is provided with a name when the game character is developed, the name needs to be displayed at the bottom of the target sequence frame, and the entire target sequence frame and the title are displayed in an overall preview form in actual game scenes. In an actual implementation, the text displaying control may be clicked on, and then the preset text is displayed at the designated position of the graphical user interface. The preset text is generally set with the size, quantity, and format of the text, as shown in FIG. 4, which displays two lines of text, namely “title effect preview” and “player name six words”. For example, players usually have their own nickname (such as “cool player”), and a name of a tribe may be displayed above the player's nickname for this game character. It should be illustrated that the position of the preset text mentioned above will not be changed, and will always be in the initial display position.

In the above-described method, the preset text can be displayed at the designated position of the graphical user interface by using the text displaying control, which is more in line with the realistic animation display effect.

In the graphical user interface, not only can the virtual object and associated object in the target sequence frame be controlled to move, but also can the target sequence frame be controlled to move. The above graphical user interface further includes a target sequence frame offset control, and the above method further includes: controlling, in response to a second operation on the target sequence frame offset control, the target sequence frame to move; and updating, based on a position of the target sequence frame after moving, position information of the target sequence frame.

Since the aforementioned adjustment of the linking information may move the virtual object or the associated object, the position of the target sequence frame may be changed, and since the position of the aforementioned preset text does not change, the target sequence frame may be overlapped with the preset text after the designated object is changed. In this embodiment, the target sequence frame may be moved through the target sequence frame offset control, and the position of the target sequence frame after moving is displayed in real time to maintain a suitable position between the target sequence frame and the preset text.

The above target sequence frame offset control is used for controlling the target sequence frame to move, and in order to simplify the operation of the developer, a plurality of offset controls with fixed moving directions may be preset, and the developer may control, through clicking on the offset controls in different directions, the target sequence frame to move in the direction, where the distance of the moving may be preset according to the actual need. The second operation described above may be clicking through the mouse on the offset controls in different directions in the target sequence frame.

In fact, as shown in FIG. 4, a selection box of “synchronize with mount offset” may be set in the vicinity of the target sequence frame offset control; after the selection box is clicked on, the target sequence frame may be controlled to move after the target sequence frame offset control is clicked on, and the moving operation therein is the same as that of the process of the controlling of the designated object, which is not repeated herein.

The above-described position information of the target sequence frame generally includes the position of the target sequence frame, and may further include the relative position of the target sequence frame and the preset text. Specifically, after the target sequence frame is controlled to move, the position of the target sequence frame after moving is displayed on the graphical user interface. Then, the position information of the position may be obtained based on the position of the target sequence frame after moving, and the position information includes the position information of the target sequence frame and the relative position information between the target sequence frame and the preset text. After the position information is obtained, the initial position information in the target resource may be updated, according to a saving operation of the developer, to the above-described position information of the target sequence frame.

In the above method, the target sequence frame corresponding to the target resource can be edited in the object editor through direct viewing, the target sequence frame is controlled to move through the target sequence frame offset control, the target sequence frame after moving is displayed in real time, and then the position information of the target sequence frame is saved, which is simple and clear to operate, simplifies the developing process of the game object, reduces the labor and time cost, and improves the animation effect of the game object.

The above target sequence frame offset control includes a plurality of target sequence frame offset sub-controls, each of the target sequence frame offset sub-controls corresponds to an offset direction, and offset directions corresponding to different target sequence frame offset sub-controls are different.

As shown in FIG. 4, in the target sequence frame offset control in the box, the above target sequence frame offset control includes four target sequence frame offset sub-controls, where a first target sequence frame offset sub-control corresponds to an offset direction of upward offset, a second target sequence frame offset sub-control corresponds to an offset direction of downward offset, a third target sequence frame offset sub-control corresponds to an offset direction of leftward offset, and a fourth target sequence frame offset sub-control corresponds to an offset direction of rightward offset.

The following specifically describes how to control the target sequence frame to move, and one possible implementation is: in response to a triggering operation on the first target sequence frame offset sub-control in the plurality of target sequence frame offset sub-controls, controlling the target sequence frame to move in a first offset direction corresponding to the first target sequence frame offset sub-control, and displaying a moving action image of the target sequence frame.

In an actual implementation, it is required to select the optional box in front of “synchronize with mount offset” in FIG. 4 first, and then click the target sequence frame offset sub-control to control the offset of the target sequence frame. At the same time, the moving action image of the target sequence frame may be displayed on the graphical user interface, which enables the developer to observe the position after the movement in real time. It should be illustrated that controlling the target sequence frame to move does not change the linking information of the virtual object and the linking information of the associated object that have been debugged in advance.

In the above method, in order to ensure that there is no shielding between the target sequence frame and the preset text, the target sequence frame may be controlled, through the target sequence frame offset control, to move in the designated direction, and the moving image is displayed in real time to achieve the desired position effect, thereby allowing for visualized debugging for the position of the target sequence frame, which is simple and convenient to operate.

The above graphical user interface further includes a target sequence frame saving control; and for the above step of updating, based on the position of the target sequence frame after moving, the position information of the target sequence frame, one possible implementation is: obtaining, in response to a triggering operation on the target sequence frame saving control, second position information of the current target sequence frame, and determining the second position information as the position information of the current target sequence frame, and as position information of all sequence frames corresponding to the target resource; and updating the second position information to the target resource.

The “save Lua” control shown in FIG. 4 is the target sequence frame saving control described above. Specifically, the developer, after moving the target sequence frame to a satisfactory position, may click on the target sequence frame saving control (corresponding to the save Lua control in the figure), and the terminal device or the back end of the terminal device may obtain, based on the position of the target sequence frame after moving, the second position information of the target sequence frame after moving, specifically the terminal device or the back end of the terminal device obtains the relative position information between the target sequence frame after moving and the preset text, and then determines the position information of the target sequence frame as obtained, and the position information of sequence frames other than the target sequence frame in the target resource as the second position information, and finally saves the second position information directly to the target resource to update and replace the initial position information of the target sequence frame.

In the above method, after the position of the currently displayed target sequence frame is adjusted, the target sequence frame saving control can, after the position of the target sequence frame is modified, directly batch process the position information of all the sequence frames at the same time and save updates to the target resource, which is simple and convenient to operate.

In the related art, if there is a problem with the depth map threshold value included in the art resource of the game object output by the related software, the artist needs to, through the PS software (Adobe Photoshop, abbreviated as “PS”, a kind of image processing software), manually adjust the edge of the depth map, manually remove the grey or white pixel, and adjust the depth map into a pure black and pure white state, in order to ensure that the front and back shielding relationship between the mount picture and the character is perfect. This adjustment method requires the PS software for batch processing, and the operation process is cumbersome.

Based on this, this embodiment provides a method for editing a game object, and this embodiment is implemented based on the above embodiments. The above graphical user interface further includes a target sequence frame editing control, and the method specifically includes: displaying, in response to a triggering operation on the target sequence frame editing control, a depth map of the target sequence frame, where a background image of the depth map is a mask map of the target sequence frame; and determining, in response to a color editing operation for the depth map, shielding relationship information between the virtual object and the associated object.

The above graphical user interface further includes the target sequence frame editing control, i.e., the “edit” control in FIG. 5, and the above depth map is mainly used for indicating the shielding relationship between the virtual object and the associated object in the target sequence frame. When the developer clicks on the target sequence frame editing control, the depth map of the target sequence frame may be displayed on the graphical user interface. In this embodiment, the mask map is set as the background of the depth map, which allows the developer to perform, according to the shielding relationship between objects in the background, the color editing operation in a visualized manner. Of course, if the background is pure white, a pure black depth picture may be displayed, which is not conducive for the developer to observe whether there is any problem with the depth map.

In an actual implementation, when the developer clicks on the target sequence frame editing control, the mouse cursor may be turned into a brush, and the size of the brush may be modified according to the “thickness” input control in FIG. 5. Generally, the finer the brush, the finer the edited range. Then the developer may select the color of the brush through the selection boxes of “white” and “black” in FIG. 5, and then in the area that needs to be modified, fill the area with white or black as needed, and click on the “load” control after completing the filling, then the shielding relationship between the virtual object and the associated object can be determined according to the current color.

In the above method, the depth map of the target sequence frame corresponding to the target resource can be edited in the object editor through direct viewing, the depth map can be cleaned directly through clicking on the editing control and then adjusting the brush size, the mask map of the target sequence frame after editing can be displayed in real time, and the shielding relationship information after editing can be saved, which is simple and clear to operate, simplifies the developing process of the game object, reduces the labor and time cost, and improves the animation effect of the game object.

The following describes how to determine the mask map of the target sequence frame. Specifically, a mask map of the virtual object is determined based on first linking information of the designated object in the target sequence frame, where the mask map includes a first color region and a second color region, and the associated object of the virtual object is located in an intermediate region between the first color region and the second color region.

Specifically, when the target sequence frame editing control is clicked on, the front and back layers, i.e., the above-described first color region and second color region, of the virtual object are automatically output according to the coordinate of the linking point position in the first linking information of the designated object in the target sequence frame, generally, the first color region is in the front layer and the second color region is in the back layer, and then the associated object is set in the intermediate region between the first color region and the second color region. It can be understood that the first color region of the virtual object is in the front, and is always shielding part of the area of the associated object. The second color region of the virtual object is at the back, and is always partially shielded by the associated object. This method reduces the amount of computation, and the output and display are convenient, without the need to manually split and optimize the synthesis technology.

In some embodiments, after the unification of art and program, the virtual object is split into front and back layers to generate resources for the front and back layers of the virtual object. The program fellow, when the game is run, only needs to combine the resources for the front and back layers of the virtual object to achieve the effect of a character normally sitting on a mount. There is no need for calculations during runtime, and the efficiency is increased by 30% compared to the original.

The following specifically describes how to determine the shielding relationship information between the virtual object and the associated object, and one possible implementation is: determining, in response to a first color filling operation for a designated region in the depth map, the shielding relationship information between the virtual object and the associated object in the designated region as the virtual object shielding the associated object; and determining, in response to a second color filling operation for the designated region in the depth map, the shielding relationship information between the virtual object and the associated object in the designated region as the associated object shielding the virtual object.

The above first color may be black, and the second color may be white. When the brush is black, after the designated area in the depth map is filled with black, the virtual object may shield the associated object in the area, and when the brush is white, after the designated area in the depth map is filled with white, the associated object may shield the virtual object in the area. The front and back shielding relationship between the virtual object and the associated object is controlled mainly by controlling the color of the brush, and similar to the principle of the depth map, the position between objects is determined. Specifically, after the filling operation is completed, the mask map and the depth map of the target sequence frame after the operation may be displayed, the shielding relationship between the virtual object and the associated object is obtained according to the displayed map, and the shielding relationship may be saved and updated when the effect is edited to a satisfactory level.

In the above method, the depth map can be processed in the editor in a visualized manner, the function can be optimized directly into the editor, and the depth map can be cleaned directly by adjusting the brush size through clicking on the editing button. This avoids processing the depth map through the PS software, and the operation is convenient and simple.

In addition, the above graphical user interface further includes other operation controls, such as “copy, paste, partially paste, zoom-in, restore, undo, recover” controls in FIG. 5. In some embodiments, clicking on the copy button may copy the current mask map information, and then clicking on the paste button may copy the information to the next frame. The partially paste is a superimposed mode, which may not completely change the next frame picture, but rather accumulates the existing change with the original mask map information. In some embodiments, the functions such as undo and recover operations improve the efficiency of image processing operations.

In addition, the above-described graphical user interface further includes an object saving control, such as the saving control below the loading control shown in FIG. 5. The above method further includes: obtaining, in response to a triggering operation on the object saving control, a spatial position corresponding to the linking information of the designated object; generating a target material by converting the spatial position corresponding to the linking information into a material, where a midpoint of the target material is the spatial position corresponding to the linking information; and imparting the target material as produced to the virtual object, rendering the virtual object, and saving the virtual object as rendered.

Specifically, the script language, such as the MAX script language (MaxScritp) is used to obtain the spatial position of the linking point in the first linking information, and the spatial position is converted to the material, thereby generating the target material, such as the Gradient material; typically, the midpoint is the spatial position of the linking point. The target material is imparted to the virtual object after the target material is produced, then rendering is performed, and the virtual object as rendered is obtained and saved. Pay attention to the spatial position and axial direction to ensure that the color gradient in the material is in the direction from the head to the tail of the virtual object.

In the prior art, in the process of producing art resources such as mounts by the developer, the resource (including the character and sequence frame mount pictures) typically exists in the SVN (Subversion, a version control system of open source code, which uses efficient management of the branch management system, in short, is used for multiple individuals to jointly develop the same project, achieves shared resources, and achieves the final centralized management) project and the outsourcing delivery P4V (Perforce Helix Core, a version control software, tracking and managing changes to source code, digital assets and large binary files, which creates a single source of data and a collaboration platform that helps teams move forward faster) project, the development resource often needs to be located in a designated directory, then the script functionality can take effect, and switching will affect function referencing. When it is required to load the resource, the developer needs to manually operate. If the outsourcing delivery resource is copied into the internal development SVN project, there are always some problems due to the existence of many developers, such as incomplete copying, read-only and non-editable problems, and saving problems.

Based on this, the above graphical user interface further includes a resource loading control; for the above step of displaying on the graphical user interface, in response to the loading operation for the target resource, the target sequence frame corresponding to the target resource, one possible implementation is: obtaining resource path information of the target resource; and displaying on the graphical user interface, in response to a triggering operation on the resource loading control, the target sequence frame corresponding to the target resource.

Specifically, the resource path information of the target resource may be obtained through the control in the dashed line box of FIG. 5, for example, by directly inputting the resource path information, or by selecting through the selecting control, in any case, there is no need to open other files for copying operations to obtain the resource path information of the target resource. After the resource path information of the target resource is obtained, the loading control in FIG. 5 may be clicked on to load the virtual object and the associated object as well as the linking information between them in the target resource, then the associated object may be linked to the virtual object according to the linking information, and the virtual object linked with the associated object may be displayed on the graphical user interface, typically displayed in the form of sequence frames.

In the above method, the resource can be loaded directly by path switching in the object editor, avoiding problems such as incomplete copying, and read-only and non-editable problems arising from manual operations. This method can solve the problem of complex resource path reading and multiple operation steps, and has a low fault tolerance rate, which greatly facilitates the workflow of the artist.

The above graphical user interface further includes a resource path input box and a resource path selecting control; and for the step of obtaining the resource path information of the target resource, one possible implementation is: obtaining the resource path information of the target resource in response to an input operation, in the resource path input box, of the resource path information of the target resource.

As for the resource path input box and the resource path selecting control shown in FIG. 5, in an actual implementation, the developer needs to select the optional box of “specify directory”, and then the resource path information of the target resource may be obtained in other files, and then copied and pasted into the resource path input box; or the resource path selecting control may be clicked to display a plurality of resource files, and the resource path information of the target resource may be obtained by copying the resource path information of the target resource and then pasting the resource path information of the target resource into the resource path input box.

Another possible implementation is: displaying selectable resource path information in response to a triggering operation on the resource path selecting control, and obtaining the resource path information of the target resource in response to a selecting operation for the resource path information of the target resource in the selectable resource path information.

In an actual implementation, the developer may click on the resource path selecting control to display a plurality of resource files, and then click to select the target resource, the resource path input box may display the resource path information of the target resource, and the resource path information of the target resource can be obtained.

In addition, the above graphical user interface further includes a resource path clearing control, which may be clicked to delete the previously selected path. It should be illustrated that when the object editor is started, the editor may obtain a preset resource path by default.

In the above method, the developer may load the resource directly in the object editor by means of selecting or inputting the path, avoiding the problems such as incomplete copying, and read-only and non-editable problems arising from manual operations. This method can solve the problem of complex resource path reading and multiple operation steps, and has a low fault tolerance rate, which greatly facilitates the workflow of the artist.

In order to enable the developer to view, in a more visualized manner, the animation effect corresponding to the target resource manner after editing the object, the above graphical user interface further includes an animation playing control; specifically, an action image corresponding to the target sequence frame is played in response to a triggering operation on the animation playing control.

As for the playing control shown in FIG. 5, when the developer clicks to play, the action image corresponding to the current target sequence frame may be played on the graphical user interface. Generally, the target resource includes a plurality of actions of the virtual object and associated object, and the user may change, based on the action switching control, such as the “←” and “→” controls in FIG. 5, the action image corresponding to the target resource being played, for example, by clicking on the control “→” for switching to the next action, the next action image corresponding to the target resource may be played. In some embodiments, the played actions are preset actions in the target resource, and specifically a series of sequence frames are played to complete the playing of the animation.

In the above method, the final animation effect may be previewed directly in the object editor, so that the developer can view the animation effect after the editing in a more visualized manner, and the production efficiency is improved.

In order to further improve the animation effect, make the animation more intuitively integrated into the scene, and achieve real-time preview of the final effect, the above graphical user interface further includes a plurality of background image displaying controls; specifically, a first background image corresponding to a first background image displaying control is displayed, in response to a triggering operation on the first background image displaying control in the plurality of background image displaying controls, in a background region of the target sequence frame.

As shown in FIG. 5, there are 12 background image displaying controls, each of the background image displaying controls corresponds to a game scene image. In an actual implementation, in the process of playing the animation, or before the animation is played, the background image of the target sequence frame that is intended to preview may be clicked on to make the played animation more intuitively integrated into the scene, so as to achieve the effect of real-time preview of the final image.

If the developer intends to update the linking point information of one of the sequence frames individually, in order to meet the requirement of the developer, the above graphical user interface further includes a copy offset control; specifically, the linking information of the designated object in the current target sequence frame is obtained in response to a triggering operation on the copy offset control; and the linking information of the designated object in the current target sequence frame is saved, in response to a switching operation for the current target sequence frame, to a sequence frame corresponding to the switching operation.

If the developer intends to adjust the linking point information of the object in a single frame, the developer may click on the copy offset control after controlling the movement of the current target sequence frame, then obtain the linking information of the designated object in the current target sequence frame, and then click on the next frame to save the obtained linking information of the designated object in the target sequence frame described above to the sequence frame of the next frame. That is to say, in the object editor, the developer can not only batch process the linking information of the object in the sequence frames, but also individually process the linking information of the object in one of the sequence frames. This type of editing and processing is more flexible.

In addition, the graphical user interface further includes a switching control for the object ID in the target sequence frame, and the user may enter the mount ID that the user intends to replace in the corresponding input box, and click on the loading control to display the replaced mount; and similarly, the user who intends to load a pendant for the character may enter the pendant ID that the user intends to replace, and click on the loading control to display the loaded pendant. The same process applies to loading and replacing operations for other object IDs.

In summary, the above method adopts a combination of the linking point and the depth map to achieve the effect of matching the 2D mount with the 3D character, and coexistence of various fashion styles.

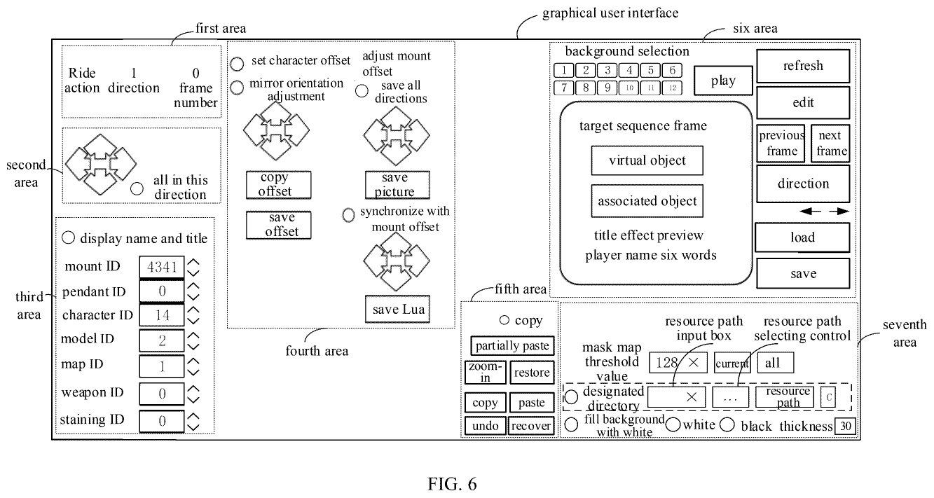

Referring to the complete graphical user interface shown in FIG. 6, it includes many areas. The specific functions of each area are introduced below. The first area displays the number, action, frame number, etc. of the current virtual object; the second area is the mask pasting mobile panel. When the mask is copied and pasted, the offset of the mask to be pasted may be adjusted. The third area is the character parameter panel, which includes the number of the associated object to be loaded, the number of the virtual object, etc.; the fourth area is the offset control panel, which adjusts the linking point and the offset of the designated object, etc.; the fifth area is the mask pasting operation panel, where may copy and paste the mask map; the sixth area is the resource displaying panel, which previews the current effect of the designated object; and the seventh area is the panel for other information, where the refresh control is used for refreshing the current modification, and the editing control is used for switching to the mask map editing mode. Since the designated object is a sequence frame resource, the editing is done frame by frame. The previous frame/next frame controls are used for switching sequence frames as needed, and the direction control is used for switching the orientation of the resource. The action control is used for switching the action of the mount (virtual object), the loading control is used for reloading the resource, and the saving control is used for saving the edited mask map.

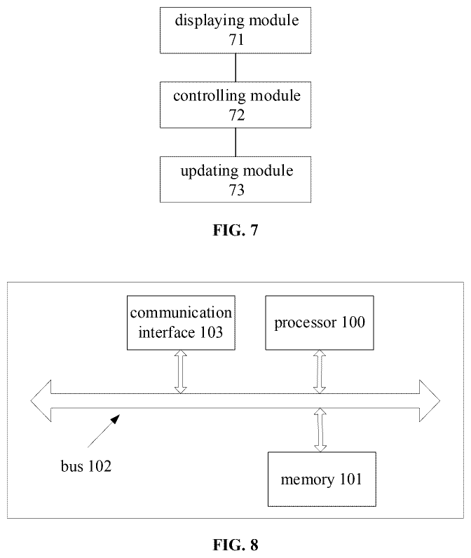

Corresponding to the method embodiments described above, the embodiments of the present disclosure provide an apparatus for editing a game object, where a graphical user interface is provided through a terminal device, and the graphical user interface includes an object offset control. As shown in FIG. 7, the apparatus includes:
a displaying module 71, configured to display on the graphical user interface, in response to a loading operation for a target resource, a target sequence frame corresponding to the target resource, where the target sequence frame includes a virtual object and an associated object of the virtual object, and the target resource further includes linking information of the virtual object and linking information of the associated object;
a controlling module 72, configured to control, in response to a first operation on the object offset control, a designated object in the target sequence frame to move, where the designated object includes the virtual object or the associated object; and
an updating module 73, configured to update, based on a position of the designated object after moving, the linking information of the designated object.

The embodiments of the present disclosure provide an apparatus for editing a game object, the target sequence frame corresponding to the target resource is displayed in response to the loading operation for the target resource, where the target sequence frame includes the virtual object and the associated object of the virtual object, and the target resource further includes the linking information of the virtual object and the linking information of the associated object; the designated object in the target sequence frame is controlled to move in response to the first operation on the object offset control, where the designated object includes the virtual object or the associated object; and the linking information of the designated object is updated based on the position of the designated object after moving. This method allows for editing the target sequence frame corresponding to the target resource through direct viewing, controlling the movement of the designated object through the object offset control, displaying the target sequence frame after the movement in real time, updating the linking information of the designated object by controlling the movement of the designated object, which is simple and clear to operate, simplifies the developing process of the game object, reduces the labor and time cost, and improves the animation effect of the game object.

Furthermore, the object offset control includes a plurality of object offset sub-controls, each of the object offset sub-controls corresponds to an offset direction, and offset directions corresponding to different object offset sub-controls are different. The controlling module is specifically configured to: control, in response to a triggering operation on a first object offset sub-control in the plurality of object offset sub-controls, the designated object to move in a first offset direction corresponding to the first object offset sub-control.

Furthermore, the graphical user interface further includes an object saving control; and the updating module is specifically configured to: obtain, in response to a triggering operation on the object saving control, first linking information corresponding to the position of the designated object after moving, and determine the first linking information as the linking information of the designated object in the target sequence frame, and as the linking information of the designated object in sequence frames other than the target sequence frame in the target resource; and save the first linking information to the target resource.

Furthermore, the updating module is specifically configured to: obtain first position information corresponding to the position of the designated object after moving; and obtain the first linking information by converting the first position information into pixel position information corresponding to the designated object.

Furthermore, the graphical user interface further includes a target sequence frame offset control; the apparatus further includes a second controlling module that is configured to control, in response to a second operation on the target sequence frame offset control, the target sequence frame to move; and the apparatus further includes a second updating module that is configured to update, based on a position of the target sequence frame after moving, position information of the target sequence frame.

Furthermore, the target sequence frame offset control includes a plurality of target sequence frame offset sub-controls, each of the target sequence frame offset sub-controls corresponds to an offset direction, and offset directions corresponding to different target sequence frame offset sub-controls are different; and the second controlling module is specifically configured to: in response to a triggering operation on a first target sequence frame offset sub-control in the plurality of target sequence frame offset sub-controls, control the target sequence frame to move in a first offset direction corresponding to the first target sequence frame offset sub-control, and display a moving action image of the target sequence frame.

Furthermore, the graphical user interface further includes a target sequence frame saving control. The second updating module is specifically configured to: obtain, in response to a triggering operation on the target sequence frame saving control, second position information of the current target sequence frame, and determine the second position information as the position information of the current target sequence frame, and as position information of all sequence frames corresponding to the target resource; and update the second position information to the target resource.

Furthermore, the graphical user interface further includes a target sequence frame editing control. The apparatus further includes a second displaying module that is configured to: display, in response to a triggering operation on the target sequence frame editing control, a depth map of the target sequence frame, where a background image of the depth map is a mask map of the target sequence frame; and the apparatus further includes a shielding relationship determining module that is configured to determine, in response to a color editing operation for the depth map, shielding relationship information between the virtual object and the associated object.

Furthermore, the apparatus further includes a mask map determining module that is configured to determine, based on first linking information of the designated object in the target sequence frame, a mask map of the virtual object, where the mask map includes a first color region and a second color region, and the associated object of the virtual object is located in an intermediate region between the first color region and the second color region.

Furthermore, the shielding relationship determining module is specifically configured to: determine, in response to a first color filling operation for a designated region in the depth map, the shielding relationship information between the virtual object and the associated object in the designated region as the virtual object shielding the associated object; and determine, in response to a second color filling operation for the designated region in the depth map, the shielding relationship information between the virtual object and the associated object in the designated region as the associated object shielding the virtual object.

Furthermore, the graphical user interface further includes an object saving control, and the apparatus further includes an object saving module that is configured to: obtain, in response to a triggering operation on the object saving control, a spatial position corresponding to the linking information of the designated object; generate a target material by converting the spatial position corresponding to the linking information into a material, where a midpoint of the target material is the spatial position corresponding to the linking information; and impart the target material as produced to the virtual object, render the virtual object, and save the virtual object as rendered.

Furthermore, the graphical user interface further includes a resource loading control; and the displaying module is specifically configured to: obtain resource path information of the target resource; and display on the graphical user interface, in response to a triggering operation on the resource loading control, the target sequence frame corresponding to the target resource.

Furthermore, the graphical user interface further includes a resource path input box and a resource path selecting control; and the displaying module is specifically configured to: obtain the resource path information of the target resource in response to an input operation, in the resource path input box, of the resource path information of the target resource; or display selectable resource path information in response to a triggering operation on the resource path selecting control, and obtain the resource path information of the target resource in response to a selecting operation for the resource path information of the target resource in the selectable resource path information.

Furthermore, the graphical user interface further includes an animation playing control, and the apparatus further includes a playing module that is configured to play, in response to a triggering operation on the animation playing control, an action image corresponding to the target sequence frame.

Furthermore, the graphical user interface further includes a plurality of background image displaying controls, and the apparatus further includes a background image displaying module that is configured to display in a background region of the target sequence frame, in response to a triggering operation on a first background image displaying control in the plurality of background image displaying controls, a first background image corresponding to the first background image displaying control.

Furthermore, the graphical user interface further includes a text displaying control, and the apparatus further includes a text displaying module that is configured to display, in response to a triggering operation on the text displaying control, a preset text at a designated position of the graphical user interface.

Furthermore, the graphical user interface further includes a copy offset control, and the apparatus further includes a copy offset module that is configured to: obtain, in response to a triggering operation on the copy offset control, the linking information of the designated object in the current target sequence frame; and save, in response to a switching operation for the current target sequence frame, the linking information of the designated object in the current target sequence frame to a sequence frame corresponding to the switching operation.

The apparatus for editing a game object provided in the embodiments of the present disclosed is provided with the same technical features as the method for editing a game object provided in the aforementioned embodiments, so the apparatus for editing a game object can also solve the same technical problems and achieve the same technical effects.

The present embodiment also provides an electronic device including a processor and a memory, where the memory stores a computer-executable instruction capable of being executed by the processor, and the processor, through executing the computer-executable instruction, implements the method for editing the game object described above. The electronic device may be a server, or may be a terminal device.

Referring to FIG. 8, the electronic device includes a processor 100 and a memory 101, where the memory 101 stores a computer-executable instruction capable of being executed by the processor 100, and the processor 100, through executing the computer-executable instruction, implements the method for editing the game object described above.

The processor 100 may also implement the following steps through executing the computer-executable instruction.

The object offset control includes a plurality of object offset sub-controls, each of the object offset sub-controls corresponds to an offset direction, and offset directions corresponding to different object offset sub-controls are different. The controlling, in response to the first operation on the object offset control, the designated object in the target sequence frame to move includes: controlling, in response to a triggering operation on a first object offset sub-control in the plurality of object offset sub-controls, the designated object to move in a first offset direction corresponding to the first object offset sub-control.

Furthermore, the graphical user interface further includes an object saving control; and the updating, based on the position of the designated object after moving, the linking information of the designated object includes: obtaining, in response to a triggering operation on the object saving control, first linking information corresponding to the position of the designated object after moving, and determining the first linking information as the linking information of the designated object in the target sequence frame, and as the linking information of the designated object in sequence frames other than the target sequence frame in the target resource; and saving the first linking information to the target resource.

Furthermore, the obtaining the first linking information corresponding to the position of the designated object after moving includes: obtaining first position information corresponding to the position of the designated object after moving; and obtaining the first linking information by converting the first position information into pixel position information corresponding to the designated object.

Furthermore, the graphical user interface further includes a target sequence frame offset control, and the method further includes: controlling, in response to a second operation on the target sequence frame offset control, the target sequence frame to move; and updating, based on a position of the target sequence frame after moving, position information of the target sequence frame.

Furthermore, the target sequence frame offset control includes a plurality of target sequence frame offset sub-controls, each of the target sequence frame offset sub-controls corresponds to an offset direction, and offset directions corresponding to different target sequence frame offset sub-controls are different; and the controlling, in response to the second operation on the target sequence frame offset control, the target sequence frame to move includes: in response to a triggering operation on a first target sequence frame offset sub-control in the plurality of target sequence frame offset sub-controls, controlling the target sequence frame to move in a first offset direction corresponding to the first target sequence frame offset sub-control, and displaying a moving action image of the target sequence frame.

Furthermore, the graphical user interface further includes a target sequence frame saving control; and the updating, based on the position of the target sequence frame after moving, the position information of the target sequence frame includes: obtaining, in response to a triggering operation on the target sequence frame saving control, second position information of the current target sequence frame, and determining the second position information as the position information of the current target sequence frame, and as position information of all sequence frames corresponding to the target resource; and updating the second position information to the target resource.

Furthermore, the graphical user interface further includes a target sequence frame editing control, and the method further includes: displaying, in response to a triggering operation on the target sequence frame editing control, a depth map of the target sequence frame, where a background image of the depth map is a mask map of the target sequence frame; and determining, in response to a color editing operation for the depth map, shielding relationship information between the virtual object and the associated object.

Furthermore, the mask map of the target sequence frame is determined by a step of: determining, based on first linking information of the designated object in the target sequence frame, a mask map of the virtual object, where the mask map includes a first color region and a second color region, and the associated object of the virtual object is located in an intermediate region between the first color region and the second color region.

Furthermore, the determining, in response to the color editing operation for the depth map, the shielding relationship information between the virtual object and the associated object includes: determining, in response to a first color filling operation for a designated region in the depth map, the shielding relationship information between the virtual object and the associated object in the designated region as the virtual object shielding the associated object; and determining, in response to a second color filling operation for the designated region in the depth map, the shielding relationship information between the virtual object and the associated object in the designated region as the associated object shielding the virtual object.

Furthermore, the graphical user interface further includes an object saving control, and the method further includes: obtaining, in response to a triggering operation on the object saving control, a spatial position corresponding to the linking information of the designated object; generating a target material by converting the spatial position corresponding to the linking information into a material, where a midpoint of the target material is the spatial position corresponding to the linking information; and imparting the target material as produced to the virtual object, rendering the virtual object, and saving the virtual object as rendered.

Furthermore, the graphical user interface further includes a resource loading control; and the displaying on the graphical user interface, in response to the loading operation for the target resource, the target sequence frame corresponding to the target resource includes: obtaining resource path information of the target resource; and displaying on the graphical user interface, in response to a triggering operation on the resource loading control, the target sequence frame corresponding to the target resource.

Furthermore, the graphical user interface further includes a resource path input box and a resource path selecting control; and the obtaining the resource path information of the target resource includes: obtaining the resource path information of the target resource in response to an input operation, in the resource path input box, of the resource path information of the target resource; or displaying selectable resource path information in response to a triggering operation on the resource path selecting control, and obtaining the resource path information of the target resource in response to a selecting operation for the resource path information of the target resource in the selectable resource path information.

Furthermore, the graphical user interface further includes an animation playing control, and the method further includes: playing, in response to a triggering operation on the animation playing control, an action image corresponding to the target sequence frame.

Furthermore, the graphical user interface further includes a plurality of background image displaying controls, and the method further includes: displaying in a background region of the target sequence frame, in response to a triggering operation on a first background image displaying control in the plurality of background image displaying controls, a first background image corresponding to the first background image displaying control.

Furthermore, the graphical user interface further includes a text displaying control, and the method further includes: displaying, in response to a triggering operation on the text displaying control, a preset text at a designated position of the graphical user interface.

Furthermore, the graphical user interface further includes a copy offset control, and the method further includes: obtaining, in response to a triggering operation on the copy offset control, the linking information of the designated object in the current target sequence frame; and saving, in response to a switching operation for the current target sequence frame, the linking information of the designated object in the current target sequence frame to a sequence frame corresponding to the switching operation.

This method allows for editing the target sequence frame corresponding to the target resource through direct viewing, controlling the movement of the designated object through the object offset control, displaying the target sequence frame after the movement in real time, updating the linking information of the designated object by controlling the movement of the designated object, which is simple and clear to operate, simplifies the developing process of the game object, reduces the labor and time cost, and improves the animation effect of the game object.

Furthermore, the electronic device shown in FIG. 8 further includes a bus 102 and a communication interface 103, and the processor 100, the communication interface 103, and the memory 101 are connected through the bus 102.

In some embodiments, the memory 101 may include a high-speed random access memory (RAM), or may also include a non-volatile memory, such as at least one disk memory. The communication connection between this system network element and at least one another network element is realized through at least one communication interface 103 (which may be wired or wireless), and the Internet, the wide area network, the local area network, the metropolitan area network, etc. may be used. The bus 102 may be an ISA bus, a PCI bus, or an EISA bus, etc. The bus may be categorized as an address bus, a data bus, a control bus, and the like. For ease of representation, only one bi-directional arrow is shown in FIG. 8 to represent the bus, but it does not indicate that there is only one bus or one type of bus.

The processor 100 may be an integrated circuit chip with signal processing capabilities. In an implementation process, the steps of the method described above may be accomplished by integrated logic circuits in the form of hardware in the processor 100 or by instructions in the form of software. The above-described processor 100 may be a general-purpose processor, including a central processing unit (CPU), a network processor (NP), etc. The processor 100 may also be a digital signal processor (DSP), an application specific integrated circuit (ASIC), a field-programmable gate array (FPGA), or other programmable logic devices, discrete gates, transistor logic devices, or discrete hardware components. Various methods, steps, and logic block diagrams disclosed in the embodiments of the present disclosure may be implemented or performed by the processor. The general-purpose processor may be a microprocessor, or the processor may also be any conventional processor, etc. The steps of the methods disclosed in conjunction with the embodiments of the present disclosure may be directly embodied to be performed for completion by a hardware decoding processor, or to be performed for completion by a combination of hardware in the decoding processor and software modules. The software module may be located in a random memory, flash memory, read-only memory, programmable read-only memory, electrically erasable programmable memory, register, or other storage medium well established in the art. The storage medium is located in the memory 101, and the processor 100 reads the information in the memory 101 to accomplish the steps of the method of the preceding embodiments in conjunction with the hardware.

The present embodiment also provides a computer-readable storage medium. The computer-readable storage medium stores a computer-executable instruction. The computer-executable instruction, when invoked and executed by a processor, causes the processor to implement the method for editing a game object described above.

The above-mentioned computer-readable storage medium may also be set to store computer-executable instructions for executing the following steps.

The object offset control includes a plurality of object offset sub-controls, each of the object offset sub-controls corresponds to an offset direction, and offset directions corresponding to different object offset sub-controls are different. The controlling, in response to the first operation on the object offset control, the designated object in the target sequence frame to move includes: controlling, in response to a triggering operation on a first object offset sub-control in the plurality of object offset sub-controls, the designated object to move in a first offset direction corresponding to the first object offset sub-control.

Furthermore, the graphical user interface further includes an object saving control; and the updating, based on the position of the designated object after moving, the linking information of the designated object includes: obtaining, in response to a triggering operation on the object saving control, first linking information corresponding to the position of the designated object after moving, and determining the first linking information as the linking information of the designated object in the target sequence frame, and as the linking information of the designated object in sequence frames other than the target sequence frame in the target resource; and saving the first linking information to the target resource.

Furthermore, the obtaining the first linking information corresponding to the position of the designated object after moving includes: obtaining first position information corresponding to the position of the designated object after moving; and obtaining the first linking information by converting the first position information into pixel position information corresponding to the designated object.

Furthermore, the graphical user interface further includes a target sequence frame offset control, and the method further includes: controlling, in response to a second operation on the target sequence frame offset control, the target sequence frame to move; and updating, based on a position of the target sequence frame after moving, position information of the target sequence frame.

Furthermore, the target sequence frame offset control includes a plurality of target sequence frame offset sub-controls, each of the target sequence frame offset sub-controls corresponds to an offset direction, and offset directions corresponding to different target sequence frame offset sub-controls are different; and the controlling, in response to the second operation on the target sequence frame offset control, the target sequence frame to move includes: in response to a triggering operation on a first target sequence frame offset sub-control in the plurality of target sequence frame offset sub-controls, controlling the target sequence frame to move in a first offset direction corresponding to the first target sequence frame offset sub-control, and displaying a moving action image of the target sequence frame.

Furthermore, the graphical user interface further includes a target sequence frame saving control; and the updating, based on the position of the target sequence frame after moving, the position information of the target sequence frame includes: obtaining, in response to a triggering operation on the target sequence frame saving control, second position information of the current target sequence frame, and determining the second position information as the position information of the current target sequence frame, and as position information of all sequence frames corresponding to the target resource; and updating the second position information to the target resource.

Furthermore, the graphical user interface further includes a target sequence frame editing control, and the method further includes: displaying, in response to a triggering operation on the target sequence frame editing control, a depth map of the target sequence frame, where a background image of the depth map is a mask map of the target sequence frame; and determining, in response to a color editing operation for the depth map, shielding relationship information between the virtual object and the associated object.

Furthermore, the mask map of the target sequence frame is determined by a step of: determining, based on first linking information of the designated object in the target sequence frame, a mask map of the virtual object, where the mask map includes a first color region and a second color region, and the associated object of the virtual object is located in an intermediate region between the first color region and the second color region.

Furthermore, the determining, in response to the color editing operation for the depth map, the shielding relationship information between the virtual object and the associated object includes: determining, in response to a first color filling operation for a designated region in the depth map, the shielding relationship information between the virtual object and the associated object in the designated region as the virtual object shielding the associated object; and determining, in response to a second color filling operation for the designated region in the depth map, the shielding relationship information between the virtual object and the associated object in the designated region as the associated object shielding the virtual object.

Furthermore, the graphical user interface further includes an object saving control, and the method further includes: obtaining, in response to a triggering operation on the object saving control, a spatial position corresponding to the linking information of the designated object; generating a target material by converting the spatial position corresponding to the linking information into a material, where a midpoint of the target material is the spatial position corresponding to the linking information; and imparting the target material as produced to the virtual object, rendering the virtual object, and saving the virtual object as rendered.

Furthermore, the graphical user interface further includes a resource loading control; and the displaying on the graphical user interface, in response to the loading operation for the target resource, the target sequence frame corresponding to the target resource includes: obtaining resource path information of the target resource; and displaying on the graphical user interface, in response to a triggering operation on the resource loading control, the target sequence frame corresponding to the target resource.

Furthermore, the graphical user interface further includes a resource path input box and a resource path selecting control; and the obtaining the resource path information of the target resource includes: obtaining the resource path information of the target resource in response to an input operation, in the resource path input box, of the resource path information of the target resource; or displaying selectable resource path information in response to a triggering operation on the resource path selecting control, and obtaining the resource path information of the target resource in response to a selecting operation for the resource path information of the target resource in the selectable resource path information.

Furthermore, the graphical user interface further includes an animation playing control, and the method further includes: playing, in response to a triggering operation on the animation playing control, an action image corresponding to the target sequence frame.

Furthermore, the graphical user interface further includes a plurality of background image displaying controls, and the method further includes: displaying in a background region of the target sequence frame, in response to a triggering operation on a first background image displaying control in the plurality of background image displaying controls, a first background image corresponding to the first background image displaying control.

Furthermore, the graphical user interface further includes a text displaying control, and the method further includes: displaying, in response to a triggering operation on the text displaying control, a preset text at a designated position of the graphical user interface.

Furthermore, the graphical user interface further includes a copy offset control, and the method further includes: obtaining, in response to a triggering operation on the copy offset control, the linking information of the designated object in the current target sequence frame; and saving, in response to a switching operation for the current target sequence frame, the linking information of the designated object in the current target sequence frame to a sequence frame corresponding to the switching operation.

This method allows for editing the target sequence frame corresponding to the target resource through direct viewing, controlling the movement of the designated object through the object offset control, displaying the target sequence frame after the movement in real time, updating the linking information of the designated object by controlling the movement of the designated object, which is simple and clear to operate, simplifies the developing process of the game object, reduces the labor and time cost, and improves the animation effect of the game object.

The computer program product of the method and apparatus for editing a game object, the electronic device, and the storage medium provided by the embodiments of the present disclosure includes a computer-readable storage medium storing program code. Instructions included in the program code may be used for performing the method in the preceding method embodiments, and the specific implementation may be referred to the method embodiments, which will not be further described herein.

Those skilled in the art can clearly understand that for the convenience and conciseness of the description, the specific working process of the system and apparatus described above may refer to the corresponding process in the aforementioned method embodiments, and will not be repeated herein.

Furthermore, in the description of the embodiments of the present disclosure, the terms “mounting”, “connecting”, and “connected” should be understood broadly, unless otherwise expressly specified and limited. For example, the connection may be a fixed connection, a detachable connection, or an integrated connection; the connection may be a mechanical connection or an electrical connection; the connection may be a direct connection or an indirect connection through an intermediate medium; or the connection may be a communication within two elements. For those ordinary skilled in the art, the specific meaning of the above terms in the present disclosure may be understood in specific cases.

If the function is implemented in the form of a software functional unit and sold or used as an independent product, it may be stored in a computer-readable storage medium. Based on this understanding, the essence of the technical solution of the present disclosure or the part of the technical solution that contributes to the prior art or part of the technical solution may be embodied in the form of a software product. The computer software product is stored in a storage medium, including one or more instructions to enable a computer device (which may be a personal computer, a server, or a network device, etc.) to perform all or part of the steps of the methods described in various embodiments of the present disclosure. The aforementioned storage medium includes: a USB flash drive, a mobile hard drive, a read only memory (ROM), a random access memory (RAM), a magnetic disk, an optical disc, or other medium that may store program code.

In the description of the present disclosure, it should be noted that the orientation or position relationship indicated by the terms “center”, “up”, “down”, “left”, “right”, “vertical”, “horizontal”, “inside”, “outside”, etc. are based on the orientation or position relationship shown in the accompanying drawings, which are only for the convenience of describing the present disclosure and simplifying the description, rather than indicating or implying that the apparatus or components referred to must have a specific orientation, or be constructed and operated in a specific orientation, therefore these terms cannot be understood as a limitation to the present disclosure. In addition, the terms “first”, “second”, and “third” are only used for descriptive purposes and are not to be construed as indicating or implying relative importance.

Finally, it should be noted that the above embodiments are only the detailed description of the present disclosure, used for illustrating the technical solutions of the present disclosure, rather than limiting the present disclosure. The scope of protection of the present disclosure is not limited to this. Although detailed explanations of the present disclosure have been provided by referring to the aforementioned embodiments, those ordinary skilled in the art should understand that any person familiar with this technical field can, within the technology scope disclosed by the present disclosure, modify the technical solutions recorded in the aforementioned embodiments or easily think of changes, or equivalently replace some of the technical features. These modifications, changes, or substitutions do not separate the essence of the corresponding technical solutions from the spirit and scope of the technical solutions of the embodiments of the present disclosure, and should be covered within the scope of protection of the present disclosure. Therefore, the scope of protection of the present disclosure shall be based on the scope of protection of the claims.

1. A method for editing a game object, comprising:
displaying on a graphical user interface, by a terminal device in response to a loading operation for a target resource, a target sequence frame corresponding to the target resource, wherein the graphical user interface is provided through the terminal device and comprises an object offset control, the target sequence frame comprises a virtual object and an associated object of the virtual object, and the target resource comprises linking information of the virtual object and linking information of the associated object;
in response to a first operation on the object offset control, controlling, by the terminal device, a designated object in the target sequence frame to move, wherein the designated object comprises the virtual object or the associated object; and
updating, by the terminal device, the linking information of the designated object based on a position of the designated object after moving.

2. The method according to claim 1, wherein the object offset control comprises a plurality of object offset sub-controls, each of the object offset sub-controls corresponds to an offset direction, and offset directions corresponding to different object offset sub-controls are different; and
the controlling the designated object to move comprises:
controlling, in response to a triggering operation on a first object offset sub-control in the plurality of object offset sub-controls, the designated object to move in a first offset direction corresponding to the first object offset sub-control.

3. The method according to claim 1, wherein the graphical user interface further comprises an object saving control; and
the updating the linking information of the designated object comprises:
obtaining, in response to a triggering operation on the object saving control, first linking information corresponding to the position of the designated object after moving, and determining the first linking information as the linking information of the designated object in the target sequence frame, and as the linking information of the designated object in sequence frames other than the target sequence frame in the target resource; and
saving the first linking information to the target resource.

4. The method according to claim 3, wherein the obtaining the first linking information comprises:
obtaining first position information corresponding to the position of the designated object after moving; and
obtaining the first linking information by converting the first position information into pixel position information corresponding to the designated object.

5. The method according to claim 1, wherein the graphical user interface further comprises a target sequence frame offset control, and the method further comprises:
controlling, in response to a second operation on the target sequence frame offset control, the target sequence frame to move; and
updating, based on a position of the target sequence frame after moving, position information of the target sequence frame.

6. The method according to claim 5, wherein the target sequence frame offset control comprises a plurality of target sequence frame offset sub-controls, each of the target sequence frame offset sub-controls corresponds to an offset direction, and offset directions corresponding to different target sequence frame offset sub-controls are different; and
the controlling the target sequence frame to move comprises:
in response to a triggering operation on a first target sequence frame offset sub-control in the plurality of target sequence frame offset sub-controls, controlling the target sequence frame to move in a first offset direction corresponding to the first target sequence frame offset sub-control, and displaying a moving action image of the target sequence frame.

7. The method according to claim 5, wherein the graphical user interface further comprises a target sequence frame saving control; and
the updating the position information of the target sequence frame comprises:
obtaining, in response to a triggering operation on the target sequence frame saving control, second position information of the target sequence frame after moving, and determining the second position information as the position information of the target sequence frame, and as position information of all other sequence frames corresponding to the target resource; and
updating the second position information to the target resource.

8. The method according to claim 1, wherein the graphical user interface further comprises a target sequence frame editing control, and the method further comprises:
displaying, in response to a triggering operation on the target sequence frame editing control, a depth map of the target sequence frame, wherein a background image of the depth map is a mask map of the target sequence frame; and
determining, in response to a color editing operation for the depth map, shielding relationship information between the virtual object and the associated object.

9. The method according to claim 8, wherein determining the mask map of the target sequence frame comprises:
determining, based on the linking information of the designated object in the target sequence frame, the mask map of the target sequence frame, wherein the mask map comprises a first color region and a second color region, and the associated object is located in an intermediate region between the first color region and the second color region.

10. The method according to claim 8, wherein the determining the shielding relationship information comprises:
determining, in response to a first color filling operation for a designated region in the depth map, the shielding relationship information between the virtual object and the associated object in the designated region as the virtual object shielding the associated object;
determining, in response to a second color filling operation for the designated region in the depth map, the shielding relationship information between the virtual object and the associated object in the designated region as the associated object shielding the virtual object.

11. The method according to claim 1, wherein the graphical user interface further comprises an object saving control, and the method further comprises:
obtaining, in response to a triggering operation on the object saving control, a spatial position corresponding to the linking information of the designated object;
generating a target material based on the spatial position, wherein a midpoint of the target material is the spatial position; and
imparting the target material to the virtual object, rendering the virtual object, and saving the virtual object as rendered.

12. The method according to claim 1, wherein the graphical user interface further comprises a resource loading control; and
the displaying target sequence frame corresponding to the target resource comprises:
obtaining resource path information of the target resource; and
displaying on the graphical user interface, in response to a triggering operation on the resource loading control, the target sequence frame corresponding to the target resource.

13. The method according to claim 12, wherein
the graphical user interface further comprises a resource path input box; and the obtaining the resource path information comprises: obtaining the resource path information in response to an input operation, in the resource path input box, of the resource path information; or
the graphical user interface further comprises a resource path selecting control; and the obtaining the resource path information comprises: displaying selectable resource path information in response to a triggering operation on the resource path selecting control, and obtaining the resource path information in response to a selecting operation for the resource path information in the selectable resource path information.

14. The method according to claim 1, wherein the graphical user interface further comprises an animation playing control, and the method further comprises:
playing, in response to a triggering operation on the animation playing control, an action image corresponding to the target sequence frame.

15. The method according to claim 1, wherein the graphical user interface further comprises a plurality of background image displaying controls, and the method further comprises:
displaying in a background region of the target sequence frame, in response to a triggering operation on a first background image displaying control in the plurality of background image displaying controls, a first background image corresponding to the first background image displaying control.

16. The method according to claim 1, wherein the graphical user interface further comprises a text displaying control, and the method further comprises:
displaying, in response to a triggering operation on the text displaying control, a preset text at a designated position of the graphical user interface.

17. The method according to claim 1, wherein the graphical user interface further comprises a copy offset control, and the method further comprises:
obtaining, in response to a triggering operation on the copy offset control, the linking information of the designated object in the target sequence frame; and
saving, in response to a switching operation for the target sequence frame, the linking information of the designated object in the target sequence frame to a sequence frame corresponding to the switching operation.

18. (canceled)

19. An electronic device, comprising a processor and a memory, wherein the memory stores a computer-executable instruction capable of being executed by the processor, and the processor, through executing the computer-executable instruction, is configured to:
display on a graphical user interface of the electronic device, in response to a loading operation for a target resource, a target sequence frame corresponding to the target resource, wherein the target sequence frame comprises a virtual object and an associated object of the virtual object, the target resource comprises linking information of the virtual object and linking information of the associated object, and the graphical user interface comprises an object offset control;
control, in response to a first operation on the object offset control, a designated object in the target sequence frame to move, wherein the designated object comprises the virtual object or the associated object; and
update, based on a position of the designated object after moving, the linking information of the designated object.

20. A non-transitory computer-readable storage medium, wherein the computer-readable storage medium stores a computer-executable instruction, and the computer-executable instruction, when invoked and executed by a processor of a device, causes the processor to perform a method for editing a game object, wherein the method comprises:
displaying on a graphical user interface of the device, in response to a loading operation for a target resource, a target sequence frame corresponding to the target resource, wherein the target sequence frame comprises a virtual object and an associated object of the virtual object, the target resource comprises linking information of the virtual object and linking information of the associated object, and the graphical user interface comprises an object offset control;
controlling, in response to a first operation on the object offset control, a designated object in the target sequence frame to move, wherein the designated object comprises the virtual object or the associated object; and
updating, based on a position of the designated object after moving, the linking information of the designated object.

21. The electronic device according to claim 19, wherein the processor is specifically configured to:
control, in response to a triggering operation on a first object offset sub-control in a plurality of object offset sub-controls, the designated object to move in a first offset direction corresponding to the first object offset sub-control, wherein the object offset control comprises the plurality of object offset sub-controls, each of the object offset sub-controls corresponds to an offset direction, and offset directions corresponding to different object offset sub-controls are different.
